(19) United States
(12) Patent Application Publication
(10) Pub. No.: US 2008/0308756 A1
(43) Pub. Date: Dec. 18, 2008

(54) ELECTROMAGNETIC VALVE

(75) Inventor: Shinichi YOSHIMURA, Tsukubamirai-shi (JP)

Correspondence Address: OBLON, SPIVAK, MCCLELLAND MAIER & NEUSTADT, P.C., 1940 DUKE STREET, ALEXANDRIA, VA, 22314, US

(73) Assignee: SMC CORPORATION, Chiyoda-ku (JP)

(21) Appl. No.: 11/950,750

(22) Filed: Dec. 5, 2007

(30) Foreign Application Priority Data
Dec. 22, 2006 (JP) 2006-346645

(51) Int. Cl. F16K 31/02

(52) U.S. Cl. 251/129.01

(57) ABSTRACT

A circular cap is slidably fitted upon an outer periphery of a tip end portion of a movable core. The movable core is biased in a direction to separate from a fixed core by means of a return spring via the cap. A tip end of a pushrod extending from a holding member for holding a valve element is allowed to be in contact with a tip end of the cap. A biasing force of the return spring is applied from the cap to the valve element via the pushrod when the movable core is separated from the fixed core by means of the return spring by demagnetization of an exciting coil, and the valve element is allowed to be in contact with a valve seat.

### TECHNICAL FIELD

The present invention relates to an electromagnetic valve provided with a switching valve portion for switching a flow path by means of a valve element in an inner part of a valve body, and an electromagnetic operation portion for driving and operating the valve element while operating a movable core by exciting and demagnetizing an exiting coil.

### BACKGROUND ART

As described in Japanese Unexamined Patent Application Publication No. 2004-156709, an electromagnetic valve provided with a switching valve portion for switching a communication condition of a flow path between ports by means of a valve element in an inner part of a valve body, and an electromagnetic operation portion for moving the valve element to each of switched position by driving a movable core by an exciting operation and a demagnetizing operation for an exciting coil is known. This kind of electromagnet valve is constructed such that the valve element is disposed between a pair of facing valve seats in a valve chamber, the valve element is biased toward the valve seat on the movable core side by means of a valve spring, a tip end portion of a pushrod extending from a holding member of the valve element comes in contact with a tip end surface of the movable core, the movable core is biased toward the valve element side by means of a return spring, and the valve element is switched by pressing the pushrod. Incidentally, in the electromagnetic valve, a cap is fixed onto an outer periphery of a tip end portion of the movable core by means of press-fitting, and a bias force of the return spring is applied to the movable core via the cap.

In the aforementioned conventional electromagnetic valve, when the exciting coil is excited, the aforementioned movable core is absorbed by a fixed core in a condition where the aforementioned return spring is compressed, and when the exciting coil is demagnetized, the movable core is rapidly separated from the fixed core by means of the bias force of the return spring. Then, the movable core presses the pushrod and switches the aforementioned valve element. Currently, energy of the movable core at (mass×velocity²)/2 is applied to the aforementioned valve element via the pushrod, and the valve element is to be collided with the valve seat by the force. However, the mass of the movable core is large and the velocity thereof is also large, and hence the aforementioned energy when the valve element is collided with the valve seat with the movable core becomes extremely large. As a result, the valve element is deformed by compression, and a life span of the valve element is reduced by that permanent distortion by compression for the valve element is increased.

### DISCLOSURE OF THE INVENTION

It is an object of the present invention in the electromagnetic valve to prevent a valve element from colliding with a valve seat at energy of (mass×velocity²)/2 of a movable core accelerated by means of a biasing force of a return spring when the valve element is switched by demagnetizing an exciting coil, and to thereby prevent the valve element from reducing a life span.

In order to solve the aforementioned problems, the present invention provides an electromagnetic valve including a switching valve portion including a valve seat in a halfway of a flow path communicating a port, and a valve element for opening and closing the flow path by contacting with and separating from the valve seat in a valve chamber of a valve body, and an electromagnetic operation portion for opening and closing the valve element by absorbing and separating a movable core to a fixed core by excitation and demagnetization of an exciting coil. Around an outer periphery of a tip end portion of the movable core, a circular cap is slidably fitted, and the cap is biased toward a tip end portion side of the movable core by means of a return spring, and is latched to the movable core by a contacting operation of a step portion provided in the cap and a step portion provided in the movable core, and a movement of the cap to a tip end side of the movable core exceeding the latched position thereof is limited. Further, the valve element is held by means of a holding member, and is biased toward the movable core side by means of a valve spring, and a pushrod is extended from the holding member, and a tip end of the pushrod is in contact with a contacting portion at a tip end of the cap, and when the valve element is in contact with the valve seat by separating the movable core from the fixed core by means of the return spring by demagnetization of the exciting coil, a biasing force of the return spring is applied from the cap to the valve element via the pushrod.

In the present invention, it is preferable that a lateral cross-sectional shape of the movable core and a hole shape of a core-fitting-in-hole of the cap have an approximately long circle shape where two semicircular portions are connected with two side edge portions, and the contacting portion is formed in the side edge portion of the cap.

Since it is effective for preventing the electromagnetic valve from growing in size that the pushrod is allowed to come in contact with a tip end surface of the cap at a position as close to a center axis line of the movable core as possible, the construction where the contacting portion is provided at a side edge portion of the cap is effective for compact sizing of the electromagnetic valve.

In this case, it is preferable that semicircular projecting portions respectively overhanging outside at positions corresponding to the two semicircular portions are formed at a tip end portion of the movable core, and the step portions of the movable core are formed of the projecting portions, and cavities are formed between the projecting portions, and semicircular concave portions are respectively formed at positions corresponding to the semicircular portions of the core-fitting-in-hole at a tip end portion of the cap, and the step portions of the cap are formed of the concave portions, and projecting portions fitting into the cavities are formed between the concave portions, and the contacting portions are formed at the positions of the projecting portion.

Furthermore, in the present invention, an impact surface where a tip end surface of the movable core is allowed to collide with and stopped when the movable core is separated from the fixed core by means of a biasing force of the return spring by demagnetization of the exciting coil may be formed in the valve body.

Alternatively, a coil spring can be allowed to intervene between facing faces of the fixed core and the movable core. As described above, when the coil spring is allowed to intervene between the fixed core and the movable core, the aforementioned return spring is able to be configured to have a biasing force appropriate for driving the valve element, and a shortfall of the biasing force required to return the movable core can be burdened by the aforementioned coil spring.

According to the present invention, since the biasing force of the aforementioned return spring is configured to be applied from the cap to the valve element via the pushrod when the aforementioned valve element is allowed to come in contact with the aforementioned valve seat by separating the movable core from the fixed core by means of the aforementioned return spring by the demagnetization of the exciting coil, there is no possibility that the valve element collides with the valve seat at the energy of (mass×velocity²)/2, when the valve element comes in contact with the valve seat, and thereby the valve element is prevented from reducing a life span thereof.

### BRIEF DESCRIPTION OF THE DRAWINGS

FIG. 1 is a longitudinal cross-sectional view illustrating an electromagnetic operation portion according to a first embodiment of the present invention when the electromagnetic operation portion is demagnetized.

FIG. 2 is a partially enlarged view illustrating an important part B of FIG. 1.

FIG. 3 is a cross-sectional view taken along a line III-III of FIG. 1.

FIG. 4 is a partially enlarged view illustrating an important part C of FIG. 3.

FIG. 5 is a longitudinal cross-sectional view illustrating the electromagnetic operation portion according to the first embodiment of the present invention when the electromagnetic operation portion is excited.

FIG. 6 is a partially enlarged view illustrating an important part D of FIG. 5.

FIG. 7 is a cross-sectional view taken along a line VII-VII of FIG. 5.

FIG. 8 is a partially enlarged view illustrating an important part E of FIG. 7.

FIG. 9 is an exploded perspective view illustrating an electromagnetic valve according to the first embodiment of the present invention.

FIG. 10 is an exploded perspective view illustrating a movable core and a cap according to the first embodiment of the present invention.

FIG. 11 is a longitudinal cross-sectional view in excitation corresponding to FIG. 7, according to a second embodiment of the present invention.

### BEST MODE FOR CARRYING OUT THE INVENTION

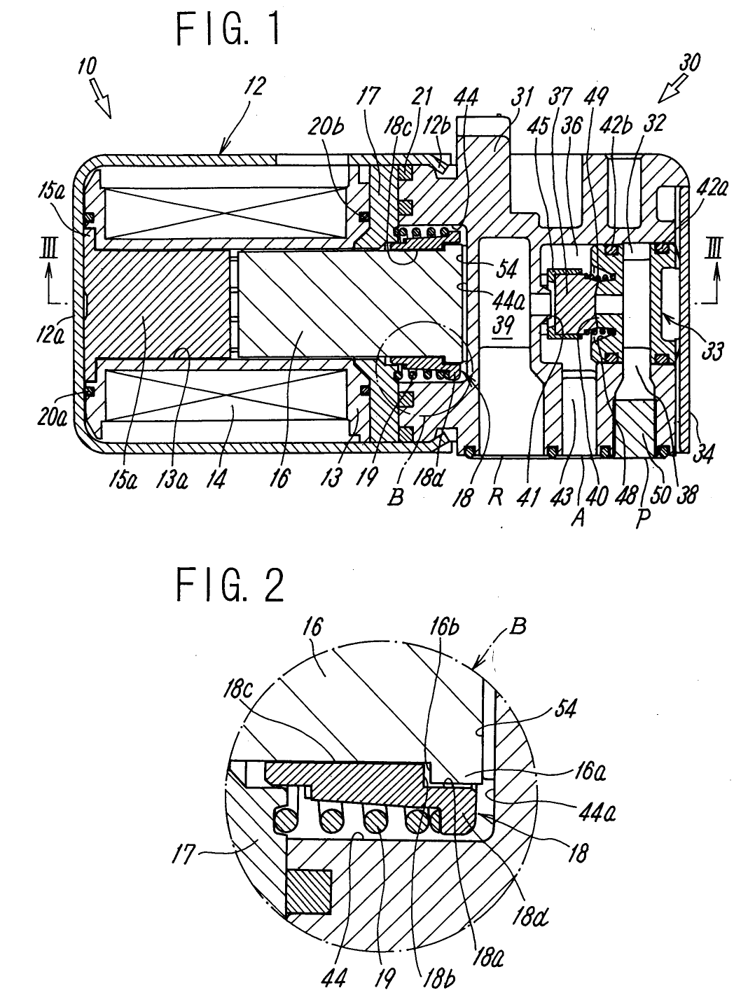

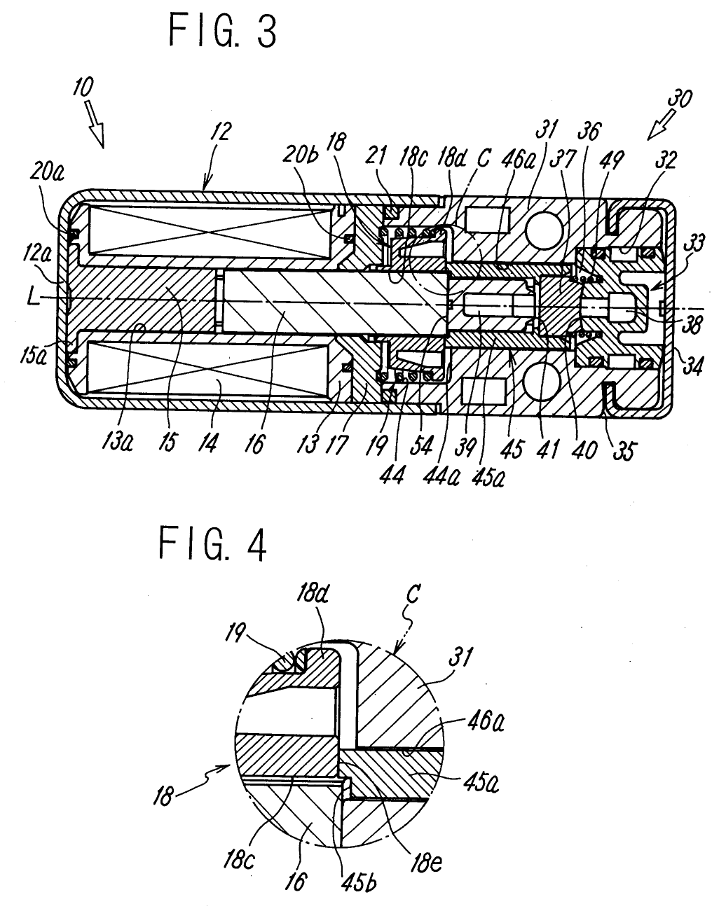

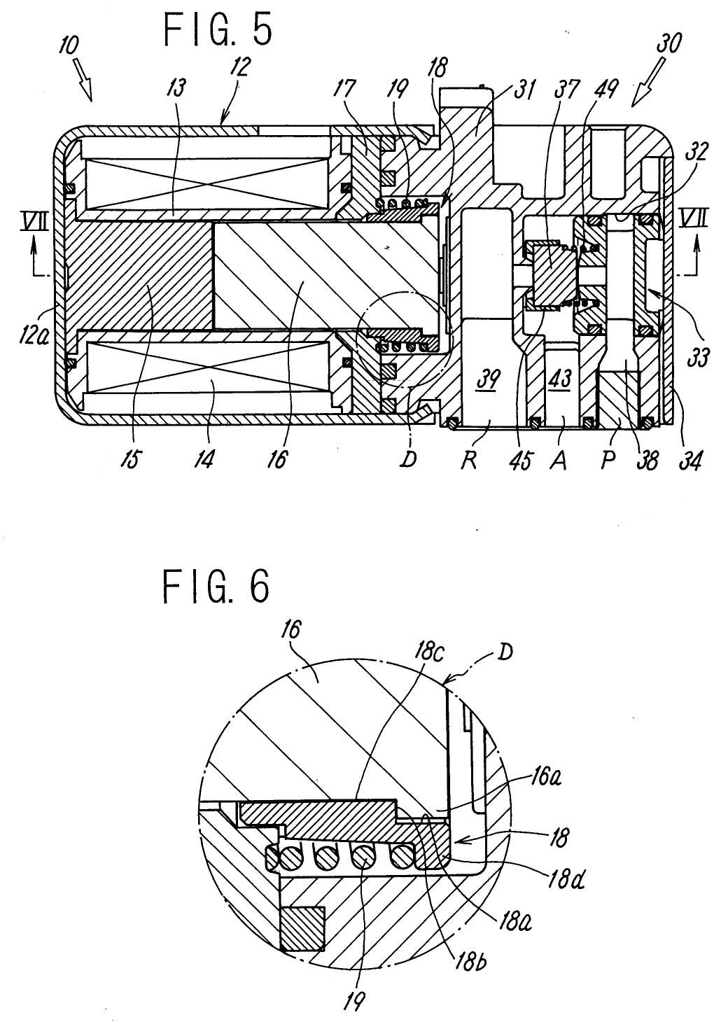

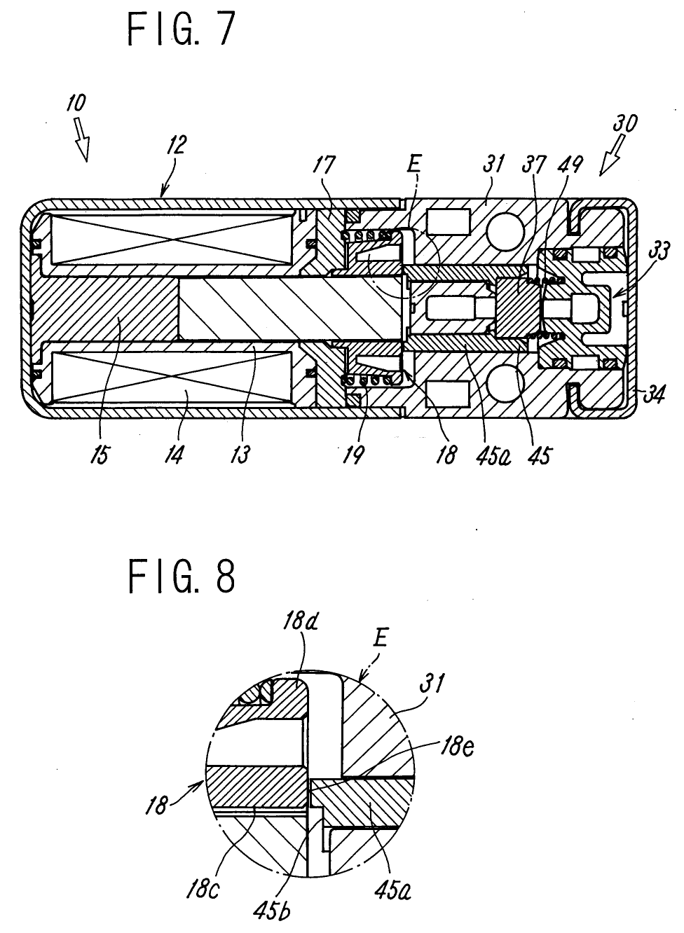

FIG. 1 through FIG. 10 illustrates a first embodiment of an electromagnetic valve according to the present invention. In the drawings, FIG. 1 and FIG. 3 illustrate a condition where an exciting coil in an electromagnetic operation portion is in demagnetization, and FIG. 5 and FIG. 7 illustrate a condition in excitation of the exciting coil. Further, when roughly divided, the electromagnetic valve is composed of an electromagnetic operation portion 10 and a switching valve portion 30.

The aforementioned electromagnetic operation portion 10 is provided with a magnetic cover 12 having a rectangular cross-section, in which a top portion 12a (left end in FIG. 1 and FIG. 3) is closed. Furthermore, in the magnetic cover 12, a circular bobbin 13 being in contact with an inner surface of the top portion 12a of the magnetic cover 12 via a sealing member 20a is disposed. An exciting coil 14 is wound around the bobbin 13, and both ends of the exciting coil 14 are connected with a non-illustrated coil terminal. In a center hole 13a of the aforementioned bobbin 13, a fixed core 15 is disposed while allowing a flange portion 15a to come in contact with the inner surface of the top portion 12a of the magnetic cover 12, and the flange portion 15a is sandwiched between the bobbin 13 and the top portion 12a of the magnetic cover 12. Moreover, in the center hole 13a of the bobbin 13, a movable core 16 is slidably fitted together by insertion in a direction to contact with and separate from the aforementioned fixed core 15.

On an opening end side of the aforementioned magnetic cover 12, a circular magnetic plate 17 is disposed, and a magnetic path between the aforementioned magnetic cover 12 and the movable core 16 is formed with the magnetic plate 17. The magnetic plate 17 is in contact with the bobbin 13 via a sealing member 20b, and a crimped portion 12b of the opening end of the aforementioned magnetic cover 12 is crimped with an engaging concave portion of a valve body 31 in the switching valve portion 30 in this condition. Thereby, the aforementioned bobbin 13 and the magnetic plate 17 are fixed in the magnetic cover 12 in a press-fitting condition. Incidentally, the sealing member 21 is disposed among three of the magnetic cover 12, the magnetic plate 17, and the valve body 31.

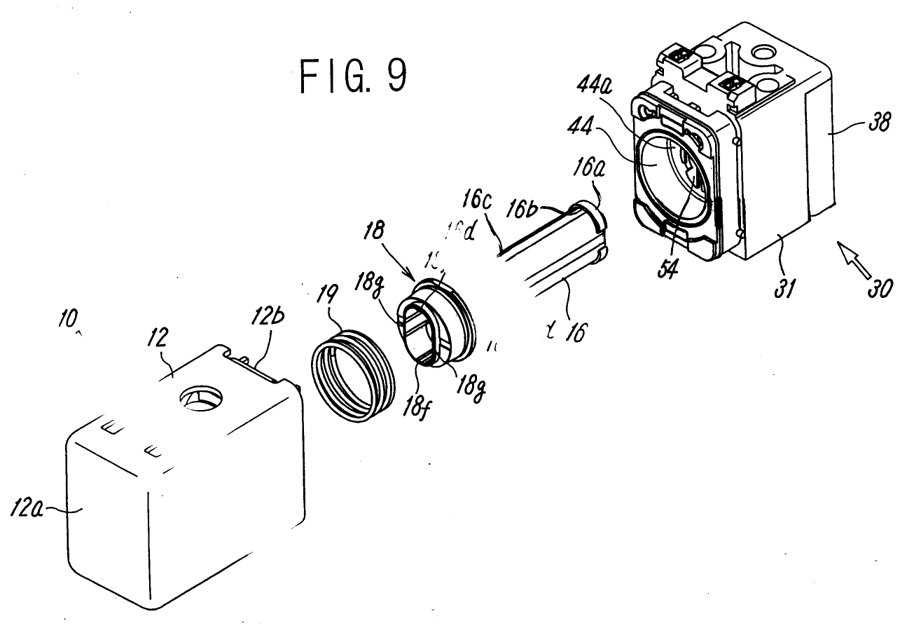

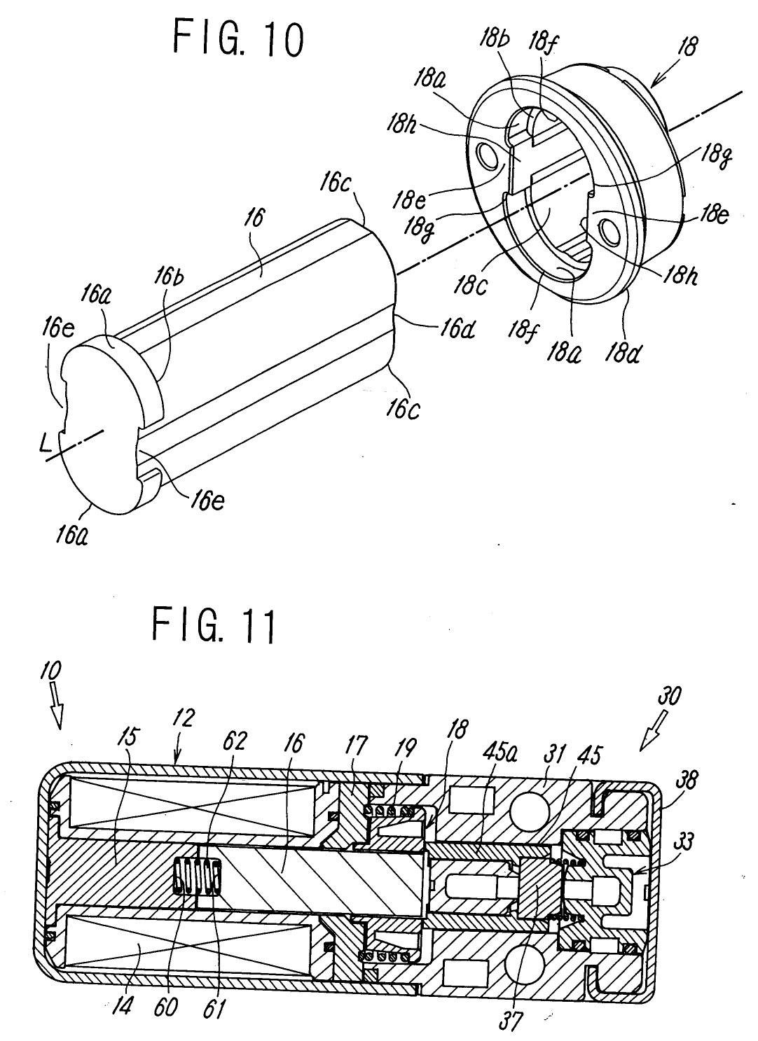

The center hole 13a of the bobbin 13 has the same shape as that of an inner hole of the magnetic plate 17, the aforementioned movable core 16 is slidably fitted together by insertion in these holes, and a tip end thereof is projected outward from the magnetic plate 17. Lateral cross-sectional shapes of the aforementioned fixed core 15 and the movable core 16 have basically approximately oval, in which two semicircle portions 16c and 16c are connected with straight or nearly straight two side edge portions 16d and 16d as illustrated in FIG. 9 and FIG. 10, and cross-sections of the center hole 13a of the bobbin 13 and the inner hole of the magnetic plate 17 being in contact with the same have approximately the same oval as well.

On the other hand, at one side surface of the valve body 31 in the switching valve portion 30, a supply port P, an output port A, and a discharge port R that open outward is opened in turn at a side end opposite to an attaching end of the electromagnetic operation portion 10, as illustrated in FIG. 1 and FIG. 5. Further, in the aforementioned valve body 31, on a center axis line of the movable core 16, a mounting hole 32 is formed at a side end opposite to an attaching end of the electromagnetic operation portion 10, a valve seat 33 is mounted in the mounting hole 32, and the valve block 33 is pressed by means of an end plate 34. The end plate 34, both end portions of which are folded back into a C-shape, as illustrated in FIG. 3, is fixed to the valve body 31 by means of inserting the both ends into an insertion grooves 0 35 provided in the valve body 31.

A valve chamber 36 is formed in an inside of the valve seat block 33 in the mounting hole 32 of the aforementioned valve body 31, and a poppet-type valve element 37 being held by a holding member 45 is housed in the valve chamber 36. Furthermore, a supply path 38 that allows the aforementioned supply port P and the valve chamber 36 to communicate with each other is formed in the aforementioned valve body 31 and the valve seat block 33, and a supply valve seat 40 is formed around an opening portion communicating with an inside of the aforementioned valve chamber 36 of the supply path 38. Incidentally, circular grooves are provided at respective positions on both sides of the aforementioned supply path 38 around an outer periphery of the aforementioned valve seat block 33, and packing 42a and 42b are respectively mounted on each of the circular grooves. Moreover, a filter 50 is mounted on the supply port P of the valve seat block 33 when required.

Further, a discharge path 39 that allows the aforementioned discharge port R and the valve chamber 36 to communicate with each other is formed in the aforementioned valve body 31, and a discharge valve seat 41 is formed around an opening portion communicating with an inside of the aforementioned valve chamber 36 of the discharge path 39. Furthermore, in the aforementioned valve chamber 36, the aforementioned supply valve seat 40 and the discharge valve seat 41 are located at positions facing each other on a center axis line L of the movable core 16, and the aforementioned poppet-type valve element 37 is positioned between these supply valve seat 40 and the discharge valve seat 41. Thereby, the valve element 37 is constructed such that a communication condition of the paths between the aforementioned ports is switched by being alternately in contact with the aforementioned facing valve seats 40 and 41. Moreover, the aforementioned valve chamber 36 is allowed to communicate with the output port A via an output path 43 extending from the side surface thereof.

A concave portion 44 having a round cross-section is formed at a center portion of an end surface on the electromagnetic operation portion 10 in the aforementioned valve body 31, and a space portion for housing the movable core 16 projecting from the magnetic plate 17 and a circular cap 18 fitted upon the tip end thereof is formed with the concave portion 44.

The aforementioned cap 18 is fitted upon an outer periphery of the movable core 16 in a slidable manner along a direction of the axis line L of the movable core 16. A hole of a core-fitting-in-hole 18c of the cap 18 where the movable core 16 fits in has the same shape as that of the lateral cross-section of the movable core 16, which is approximately oval in which two semicircle portions 18f and 18f are connected with two straight or nearly straight side edge portions 18g and 18g. The aforementioned movable core 16 is fitted into the core-fitting-in-hole 18c while allowing a minute gap to intervene between a hole wall and the movable core 16. A step portion 18b facing a step portion 16b that is provided at a tip end portion of the aforementioned movable core 16 is provided in an inner surface of the cap 18 as described later with reference to FIG. 2 and FIG. 6. The cap 18 is prevented from being pulled out toward a front end portion side of the movable core 16, namely the switching valve portion 30 side by that both of these step portions 16b and 18b come in contact with each other.

That is, the aforementioned movable core 16 is provided with the two semicircle portions 16c and 16c at facing positions in the lateral cross-section thereof, and two projecting portions 16a and 16a having semicircular shape projecting in a direction perpendicular to the center axis line L of the movable core 16 are integrally provided at outsides of the aforementioned respective semicircular portions 16c and 16c at a tip end portion of the movable core 16, as clearly illustrated in FIG. 2 and FIG. 6, and the aforementioned semicircular step portion 16b facing the fixed core 15 side is formed at the tip end portion of the movable core 16 with these projecting portions 16a and 16a. Two cavities 16e and 16e continuing into the aforementioned side edge portions 16d and 16d are formed at positions between the aforementioned two projecting portions 16a and 16a facing each other.

On the other hand, two concave portions 18a and 18a fitting upon the aforementioned projecting portions 16a and 16a are formed in an inner surface on a tip end side of the core-fitting-in-hole 18c in the aforementioned cap 18. The portion in the concave portion 18a, which faces the step portion 16b of the aforementioned projecting portion 16a is configured to be the step portion 18b in the cap 18. Hence, the aforementioned concave portion 18a and the step portion 18b have a semicircular shape as well. In addition, since both of these step portions 16b and 18b come in contact with each other, the aforementioned cap 18 does not move further relative the movable core 16 toward the switching valve portion 30 side. Further, two projecting wall portions 18h and 18h projecting inside the aforementioned core-fitting-in-hole 18c are formed at facing positions between the aforementioned two concave portions 18a and 18a in the cap 18.

On the other hand, the cap 18 is provided with a flange portion 18d outside the tip end portion thereof, and is biased toward the valve element 37 side of the switching valve portion 30 by means of a return spring 19 being compressed between the flange portion 18d and the magnetic plate 17. Hence, when the aforementioned movable core 16 is driven in a direction to be separated from the fixed core 15 by means of the biasing force of the return spring 19 by the demagnetization of the exciting coil 14, the biasing force of the aforementioned return spring 19 is transmitted to the movable core 16 via the cap 18 by that the step portion 18b of the aforementioned cap 18 comes in contact with the step portion 16b of the movable core 16. However, there is no possibility that energy of movement of the movable core 16 is transmitted to the cap 18.

Further, as illustrated in FIG. 3 and FIG. 7, a pair of guide holes 46a positioned on both sides of the aforementioned discharge path 39, and passing through the valve body 31 is provided between a spatial portion formed with the concave portion 44 at an end surface of the electromagnetic operation portion 10 side in the aforementioned valve body 31 and the valve chamber 36. A pair of pushrods 45a provided in the holding member 45 of the valve element 37 is inserted into the guide holes 46a. A valve spring 49 is allowed to intervene between the aforementioned valve element 37 and a circular supporting groove 48 provided at an outside of the supply valve seat 40. The valve element 37 is biased toward the discharge valve seat 41, namely a switching position on the movable core side by means of the valve spring 49.

A tip end of the aforementioned pushrod 45a is allowed to be in contact with a front surface of a contacting portion 18e formed at a center position of two side edge portions 18g and 18g at a tip end of the aforementioned cap 18 without being in contact with the aforementioned movable core 16. The biasing force of the return spring 19 is configured to be applied to the pushrod 45a via the cap 18. The aforementioned contacting portion 18e is formed from a tip end portion of the aforementioned projecting wall portion 18h.

In the first embodiment illustrated in the drawings, since a portion facing a tip end surface of the movable core 16 exists at a tip end portion of the pushrod 45a, as is clearly illustrated in FIG. 4, a cut out portion 45b for avoiding the portion to be in contact with the movable core 16 is formed at a tip end of the pushrod 45a. Because of existence of the cut out portion 45b, the tip end portion of the pushrod 45a is configured to be in contact with only the contacting portion 18e of the cap 18.

Furthermore, as illustrated in FIG. 1 and FIG. 2, in an inner bottom surface 44a of the aforementioned concave portion 44, a flat impact surface 54 projecting toward the movable core 16 side is formed, and an outer periphery of the impact surface 54 is positioned on a side inner than an outer peripheral surface of the tip end surface of the movable core 16. Thereby, when the exciting coil 14 is demagnetized and thus an absorption force between the fixed core 15 and the movable core 16 is lost and the return spring 19 is extended, ordinarily, the tip end surface of the movable core 16 collides with the aforementioned impact surface 54 after the flow path between the ports is switched by means of the valve element 37, and the movement of the movable core 16 is stopped at this moment. Moreover, the biasing force of the return spring 19 allows the valve element 37 to be in pressure contact with the supply valve seat 40 via the aforementioned cap 18 and the pushrod 45a in a condition where the movable core 16 is in contact with the aforementioned impact surface 54 and stopped. Hence, when the tip end surface of the movable core 16 is in contact with the impact surface 54, a clearance exists between the step portion 16b of the movable core 16 and the step portion 18b of the cap 18.

Next, an operation of the aforementioned first embodiment will be explained.

As illustrated in FIG. 5 through FIG. 8, when the exciting coil 14 is excited, the absorption force is generated between the fixed core 15 and the movable core 16, and the movable core 16, and the movable core 16 is absorbed by means of the fixed core 15 by the absorption force in a condition where the return spring 19 is compressed. Hence, the valve element 37 is in contact with the discharge valve seat 41 by means of the biasing force of the valve spring 49, communication between the valve chamber 36 and the discharge port R is interrupted, the supply port P and the output port A are allowed to communicate with each other, and compressed air from the supply port P is output through the valve chamber 36, the output path 43, and the output port A.

When the exciting coil 14 is demagnetized, the return spring 19 is extended against the biasing force of the valve spring 49 by losing the electromagnetic absorption force of the fixed core 15, and the cap 18 and the movable core 16 is moved to the switching valve portion 30 side. Therefore, the valve element 37 is switched via the pushrod 45a, and the switching condition of the electrode valve is changed from that illustrated in FIG. 5 through FIG. 8, to that illustrated in FIG. 1 through FIG. 4. In this switching operation, since the aforementioned movable core 16 stops at a position where the tip end surface thereof collides with the impact surface 54, the biasing force of the return spring 19 is transmitted to the valve element 37 via the aforementioned cap 18 and the pushrod 45a, and presses the valve element 37 to the supply valve seat 40. As a result, the communication between the supply port P and the valve chamber 36 is interrupted, the output port A and the discharge port R are allowed to communicate with each other, and the compressed air on the output port A side is discharged to the ambient air through the valve chamber 36 and the discharge port R.

FIG. 11 illustrates a second embodiment of an electromagnetic valve according to the present invention. In the second embodiment, spring-receiving holes 60 and 61 are respectively provided at facing surfaces of the fixed core 15 and the movable core 16 having a similar construction as that of the first embodiment, and a coil spring 62 is allowed to intervene in between thereof. Although a depth of the spring-receiving hole 60 on the side of the fixing core 15 and the depth of the spring-receiving hole 61 on the side of the movable core 16 side are configured to be approximately identical in FIG. 11, it is applicable that the depth of one side thereof may be larger than or smaller than the depth of the other side thereof. Other construction of the second embodiment is not substantially different from that of the first embodiment.

Thus, by means of allowing the coil spring 62 to intervene between facing surfaces of the fixed core 15 and the movable core 16 separately from the return spring 19, the aforementioned return spring 19 is able to be configured to have a biasing force appropriate for switching the valve element 37, and a shortfall of the biasing force required to return the movable core 16 can be burdened by the aforementioned coil spring 62. Hence, a response of the electromagnetic valve can be appropriately set while increasing a life span of the valve element 37.

Other construction and operation of the second embodiment are similar to that of the first embodiment. Accordingly, in FIG. 11, the same numerical references as the first embodiment are attached to the same or corresponding important components as that in the first embodiment and the explanation therefor is omitted.

Incidentally, although in the embodiment illustrated in the drawings, a three-port electromagnetic valve is shown, the present invention is applicable to a two-port electromagnetic valve provided with a supply port P and an output port A.

1. An electromagnetic valve comprising:
a switching valve portion including
a valve seat in a halfway of a flow path communicating a port, and
a valve element for opening and closing the flow path by contacting with and separating from the valve seat in a valve chamber of a valve body; and
an electromagnetic operation portion for opening and closing the valve element by absorbing and separating a movable core to a fixed core by excitation and demagnetization of an exciting coil,
wherein around an outer periphery of a tip end portion of the movable core, a circular cap is slidably fitted, and the cap is biased toward a tip end portion side of the movable core by means of a return spring, and is latched to the movable core by a contacting operation of a step portion provided in the cap and a step portion provided in the movable core, and a movement of the cap to a tip end side of the movable core exceeding the latched position thereof is limited, and
wherein the valve element is held by means of a holding member, and is biased toward the movable core side by means of a valve spring, and a pushrod is extended from the holding member, and a tip end of the pushrod is in contact with a contacting portion at a tip end of the cap, and when the valve element is in contact with the valve seat by separating the movable core from the fixed core by means of the return spring by demagnetization of the exciting coil, a biasing force of the return spring is applied from the cap to the valve element via the pushrod.

2. The electromagnetic valve according to claim 1, wherein a lateral cross-sectional shape of the movable core and a hole shape of a core-fitting-in-hole of the cap have an approximately long circle shape where two semicircular portions are connected with two side edge portions, and the contacting portion is formed in the side edge portion of the cap.

3. The electromagnetic valve according to claim 2, wherein semicircular projecting portions respectively overhanging outward on outer periphery sides at positions corresponding to the two semicircular portions are formed at a tip end portion of the movable core, and the step portions of the movable core are formed of the projecting portions, and cavities are formed between the projecting portions, and wherein semicircular concave portions are respectively formed at positions corresponding to the semicircular portions of the core-fitting-in-hole at a tip end portion of the cap, and the step portions of the cap are formed of the concave portions, and projecting portions fitting into the cavities are formed between the concave portions, and the contacting portions are formed at the positions of the projecting portion.

4. The electromagnetic valve according to claim 1, wherein an impact surface where a tip end surface of the movable core is allowed to collide with and stopped when the movable core is separated from the fixed core by means of a biasing force of the return spring by demagnetization of the exciting coil is formed in the valve body.

5. The electromagnetic valve according to claim 2, wherein an impact surface where a tip end surface of the movable core is allowed to collide with and stopped when the movable core is separated from the fixed core by means of a biasing force of the return spring by demagnetization of the exciting coil is formed in the valve body.

6. The electromagnetic valve according to claim 3, wherein an impact surface where a tip end surface of the movable core is allowed to collide with and stopped when the movable core is separated from the fixed core by means of a biasing force of the return spring by demagnetization of the exciting coil is formed in the valve body.

7. The electromagnetic valve according to claim 1, wherein a coil spring is allowed to intervene between facing faces of the fixed core and the movable core.

8. The electromagnetic valve according to claim 2, wherein a coil spring is allowed to intervene between facing faces of the fixed core and the movable core.

9. The electromagnetic valve according to claim 3, wherein a coil spring is allowed to intervene between facing faces of the fixed core and the movable core.

10. The electromagnetic valve according to claim 4, wherein a coil spring is allowed to intervene between facing faces of the fixed core and the movable core.

11. The electromagnetic valve according to claim 5, wherein a coil spring is allowed to intervene between facing faces of the fixed core and the movable core.

12. The electromagnetic valve according to claim 6, wherein a coil spring is allowed to intervene between facing faces of the fixed core and the movable core.
